(19) United States
(12) Patent Application Publication
(10) Pub. No.: US 2015/0124892 A1
(43) Pub. Date: May 7, 2015

(54) RADIO COMMUNICATION SYSTEM AND METHOD

(71) Applicant: DENSO CORPORATION, Kariya-city (JP)

(72) Inventors: Yuji SUGIMOTO, Kariya-city (JP); Tadao SUZUKI, Kariya-city (JP); Yasumune YUKIZAKI, Okazaki-city (JP)

(21) Appl. No.: 14/529,696

(22) Filed: Oct. 31, 2014

(30) Foreign Application Priority Data
Nov. 1, 2013 (JP) 2013-228439

(51) Int. Cl. H04B 3/06; H04L 25/02; H04B 1/04

(52) U.S. Cl. CPC H04B 3/06; H04B 1/04; H04L 25/028
USPC 375/257

(57) ABSTRACT

A radio communications system includes a communication radio and an antenna module positioned external to the communication radio. An antenna cable connects the radio and the antenna module. The radio superposes a power voltage for operating the antenna module on a signal line of the antenna cable and transmits to the antenna module through the antenna cable a control signal that controls a gain of a transmission amplifier and duplexers while the transmission signal is not transmitted therethrough. In such manner, a control of the antenna module is enabled without affecting the transmission signal.

### CROSS REFERENCE TO RELATED APPLICATION

The present application is based on and claims the benefit of priority of Japanese Patent Application No. 2013-228439, filed on Nov. 1, 2013, the disclosure of which is incorporated herein by reference,

### TECHNICAL FIELD

The present disclosure generally relates to a radio communication system and method having a communication radio that is connected to an antenna side device with one transmission line.

### BACKGROUND INFORMATION

The radio communication system disclosed in a patent document 1 (i.e., Japanese Patent Laid-Open No. 2003-244018) includes a communication radio, such as a burst modem, and an antenna side device, such as an outdoor device, for performing amplification, etc., at the time of transmission and reception positioned at distant positions from each other. The communication radio and the antenna side device are connected by a single coaxial cable. Through the coaxial cable, a transmission signal is sent to the antenna side device from the communication radio and a reception signal is sent to the communication radio from the antenna side device.

In addition, a signal detection circuit is provided in the antenna side device. When the level of a transmission signal is higher than a threshold, a transmission amplifier is connected to an antenna. When the level of a transmission signal is equal to or lower than the threshold, a reception amplifier is connected to the antenna. In such configuration, the switching of amplifiers, that is, between the transmission amplifier and the reception amplifier at the time of switching between signal transmission and signal reception, is performed only with the single coaxial cable that is used for both transmission and reception of the signal.

In the above-described configuration for the switching of amplifiers based on the level of the transmission signal, a certain period of time is required between the rise of the level of the transmission signal and a desired amplification of the signal because time is required for the switching of a switch that switches amplifiers and a starting of the transmission amplifier. Therefore, a front portion (i.e., front edge) of a waveform of the transmission signal may be dropped or deformed. In other words, the waveform may be deteriorated. If the degree of such waveform deformation is severe, the receiving side may not be capable of demodulating the transmission signal.

### SUMMARY

It is an object of the present disclosure to provide a radio communication system and method that is configured to control an antenna side device while preventing an influence on a transmission signal.

In an aspect of the present disclosure, a radio communication system including a radio, an antenna side device positioned external to the radio, and a transmission line connecting the radio to the antenna side device and supplying an electric power to the antenna side device. The radio outputs a transmission signal to the antenna side device through the transmission line by superposing the transmission signal on a power voltage, and the antenna side device outputs the transmission signal as a radio wave. The radio outputs a control signal to the antenna side device through the transmission line by superposing the control signal on the power voltage during a time when the radio does not output the transmission signal to the antenna side device.

Further, in an aspect of the present disclosure, the antenna side device outputs a reception signal that is indicative of a received radio wave to the radio through the transmission line. During a time when the antenna side device does not receive the transmission signal or the control signal from the radio, the antenna side device outputs a feedback signal that notifies a state of the antenna side device to the radio through the transmission line. The control signal being a signal that is determined based on the feedback signal.

In another aspect of the present disclosure, the antenna side device includes a temperature detection circuit and a transmission amplifier with a variable gain, the feedback signal is a signal indicative of a detected temperature from the temperature detection circuit, and the control signal includes a gain control signal that controls a gain of the transmission amplifier.

In yet another aspect of the present disclosure, after outputting to the antenna side device the control signal, which includes a transmission mode signal for a switching of the antenna side device to a transmission mode, the radio starts to output the transmission signal to the antenna side device at a transmission start timing that is determined based on a required switch time for the switching of the antenna side device to the transmission mode.

In a further aspect of the present disclosure, an Inter Frame Space (IFS) time is a time period after a busy-to-idle state transition of a communication channel, a back-off time is a time period subsequent to the IFS time, and based on carrier sensing of the communication channel, the radio outputs the control signal during the IFS time or the back-off time.

Moreover, in an aspect of the present disclosure, the carrier sensing of the communication channel is repeatedly performed at a preset timing.

In another aspect of the present disclosure, a communication radio includes a radio section, an antenna side device positioned external to the radio section, and a transmission line connecting the radio section to the antenna side device and supplying an electric power to the antenna side device. The radio section outputs a transmission signal to the antenna side device through the transmission line by superposing the transmission signal on a power voltage, and the antenna side device outputs the transmission signal as a radio wave. The radio section outputs a control signal to the antenna side device through the transmission line by superposing the control signal on the power voltage during a time when the radio section does not output the transmission signal to the antenna side device.

In yet another aspect of the present disclosure, a communication antenna includes a radio section, an antenna section positioned external to the radio section, and a transmission line connecting the radio section to the antenna section and supplying an electric power to the antenna section. The radio section outputs a transmission signal to the antenna section through the transmission line by superposing the transmission signal on a power voltage, and the antenna section outputs the transmission signal as a radio wave. The radio section outputs a control signal to the antenna section through the transmission line by superposing the control signal on the power voltage during a time when the radio section does not output the transmission signal to the antenna section.

In a further aspect of the present disclosure, a method for communicating using a radio communication system having a radio, an antenna side device that is positioned external to the radio, and a transmission line that connects the radio to the antenna side device and supplies an electric power to the antenna side device, includes superposing a transmission signal on a power voltage, outputting the transmission signal from the radio to the antenna side device through the transmission line as a radio wave, superposing a control signal on the power voltage, and outputting the control signal from the radio to the antenna side device through the transmission line when the radio does not output the transmission signal to the antenna side device.

Even further, in an aspect of the present disclosure, the method for communicating using a radio communication system also includes outputting a reception signal that is indicative of a received radio wave from the antenna side device to the radio through the transmission line, and outputting a feedback signal that notifies a state of the antenna side device from the antenna side device to the radio through the transmission line during a time when the antenna side device does not receive the transmission signal or the control signal from the radio.

Moreover, in an aspect of the present disclosure, outputting the transmission signal from the radio to the antenna side device is started at a transmission start timing that is determined based on a required switch time for the switching of the antenna side device to the transmission mode after outputting the control signal from the radio to the antenna side device, which includes a transmission mode signal for a switching of the antenna side device to a transmission mode.

According to the present disclosure, the communication radio controls the antenna side device by the control signal that is different from the transmission signal, and transmission of the control signal superposed on the electric power voltage through the transmission line to the antenna side device is performed when the transmission signal is not transmitted to the antenna side device. Therefore, a control of the antenna side device is performed without affecting the transmission signal.

Further, the communication radio and the antenna side device for achieving the above-mentioned purpose are the communication radio and the antenna side device in the above-mentioned radio communication system.

Numerals in a parenthesis in the claims indicate a correspondence to concrete examples in an embodiment, which suggests one mode of the disclosure, and thus do not limit a technical scope of the present disclosure.

### BRIEF DESCRIPTION OF THE DRAWINGS

Objects, features, and advantages of the present disclosure may become more apparent from the following detailed description made with reference to the accompanying drawings, in which:

FIG. 1 is a configuration diagram of a radio communication system in an embodiment of the present disclosure;

FIG. 2 is an example format of a control signal;

FIG. 3 is a diagram of a relation between a signal pattern of the control signal and an amplifier gain; and

FIG. 4 is a time chart of a voltage level in an antenna cable.

### DETAILED DESCRIPTION

### Configuration of a Whole System

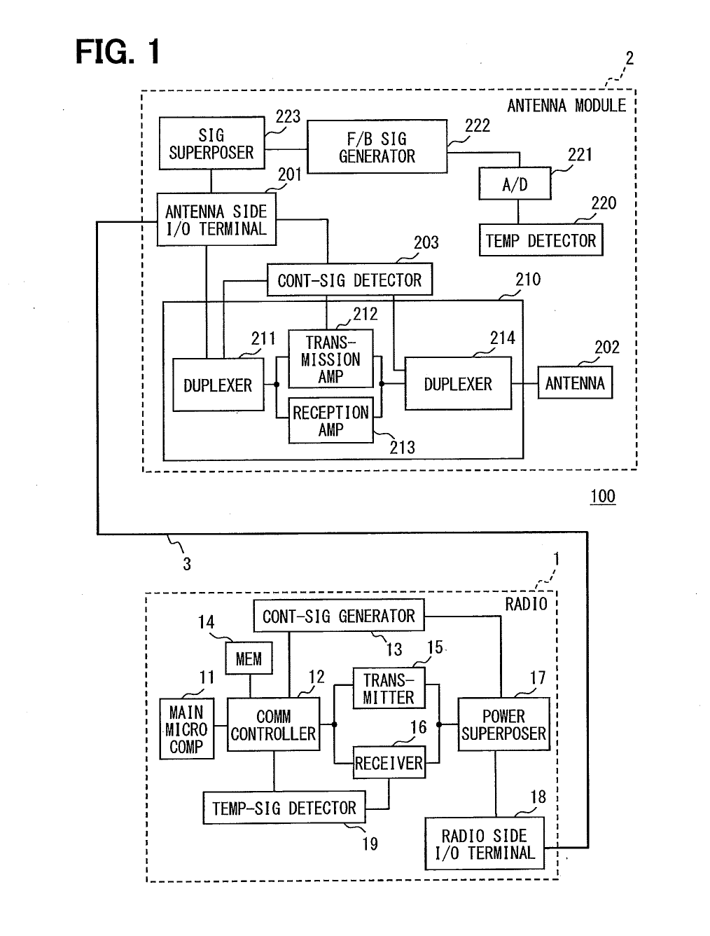

A radio communication system 100 shown in FIG. 1 includes a communication radio 1 and an antenna module 2 (i.e., equivalent to an antenna side device) which are connected via an antenna cable 3.

The antenna cable 3 is a coaxial cable, for example. The antenna cable 3 is equivalent to a transmission line in the claims. According to the present embodiment, the following example is described as a case in which the radio communication system 100 is installed in a vehicle.

The radio communication system 100 performs either or both of a vehicle-to-vehicle communication and a road-to-vehicle communication, for example. The communication frequency used in such vehicle-to-vehicle communication and the road-to-vehicle communication may be a 700 MHz band and a 5.9 GHz band, for example.

The antenna module 2 is disposed, for example, on an external surface of a vehicle roof. On the other hand, the communication radio 1 is disposed at a predetermined position in the vehicle. The position of the communication radio 1 in the vehicle is not restricted to a specific one, but, due to its use of electronic components, it may be preferable to dispose the radio 1 in an environment that is not susceptible to a temperature change by a sun beam or the like.

### Configuration of the Communication Radio 1

The communication radio 1 is provided with a main microcomputer 11, a communication controller 12, a control signal generator 13, a memory 14, a transmitter 15, a receiver 16, a power superposer 17, a communication radio side I/O terminal 18, and a temperature signal detector 19 as shown in FIG. 1.

The main microcomputer 11 performs transmit data generation, processing of receive data, and the like.

The communication controller 12 performs various controls about transmission and reception of data. For example, the communication controller 12 sends out transmission data to the transmitter 15, when transmission data has been transmitted from the main microcomputer 11.

Regarding the transmission data, it is stored in the memory 14 temporarily, for example, and, when it is determined that a correct transmission timing has arrived for transmitting the transmission data, the transmission data is sent out in order. The transmission timing of the transmission data is determined by carrier sensing. The determination of the transmission timing based on carrier sensing is described later.

The transmission data temporarily stored in the memory 14 is erased when it is sent out from the communication controller 12. The transmission data sent out from the communication controller 12 is modulated by the transmitter 15. The modulated data is designated as a transmission signal. The transmission signal is sent to the power superposer 17.

Further, when the reception data that is demodulated by the receiver 16 is input to the communication controller 12 after reception by the antenna module 2 and transmission through the antenna cable 3, the communication radio side I/O terminal 18, the power superposer 17, the communication controller 12 inputs this demodulated data to the main microcomputer 11.

Although, in the present embodiment, the communication controller 12 is configured to receive the transmission data from the main microcomputer 11 and to input the reception data to the main microcomputer 11, such a configuration is not a binding one. For example, the communication controller 12 may receive the transmission data from other apparatus via a data communications interface, or may transmit the reception data to the other apparatus via such an interface.

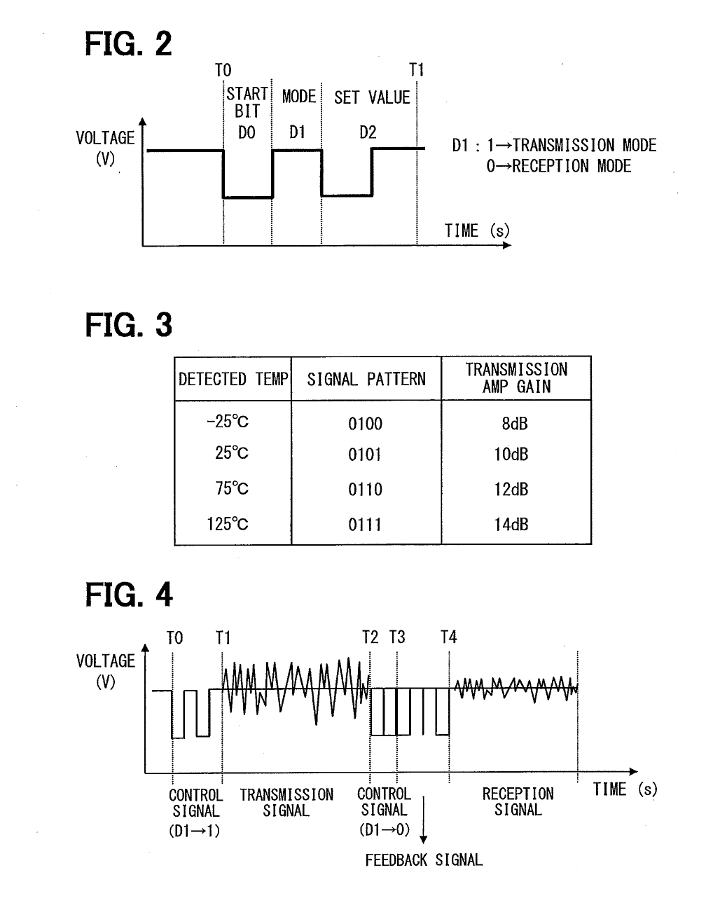

The control signal generator 13 generates a control signal for controlling the antenna module 2, and transmits the generated control signal to the power superposer 17 during a time when the transmission signal is not transmitted. The control signal includes, in the present embodiment, an instruction signal that instructs a communicate mode of the antenna module 2 to a transmission mode or to a reception mode, and a gain signal that controls a gain of a transmission amplifier 212 of the antenna module 2. The example of the control signal is described later with reference to FIG. 2 and FIG. 3.

The power superposer 17 superposes the transmission signal inputted from the transmitter 15 and/or the control signal inputted from the control signal generator 13 on the electric power voltage. A superposed signal which is made up from the transmission signal or the control signal superposed on the electric power voltage is transmitted to the antenna module 2 after orderly passing through the communication radio side I/O terminal 18 and a signal line of the antenna cable 3. Further, when no transmission signal and no control signal are inputted into the power superposer 17, the power superposer 17 inputs the electric power voltage into the communication radio side I/O terminal 18.

Further, when the antenna module 2 is in the reception mode, the reception signal is superposed on the electric power voltage, and the reception signal is inputted to the power superposer 17 through the antenna cable 3 and the communication radio side I/O terminal 18. In the reception mode, the receiver 16 demodulates the reception signal superposed on the electric power voltage, and takes out the reception data.

The temperature signal detector 19 detects a feedback signal from the reception data. The feedback signal includes information which shows temperature of the antenna module 2. The temperature signal detector 19 transmits the detected feedback signal to the communication controller 12.

The communication controller 12 determines a gain of the transmission amplifier 212 of the antenna module 2 according to the feedback signal. Then, the determined gain is notified to the control signal generator 13. The control signal generator 13 generates a control signal corresponding to the determined gain, when a gain is notified from the communication controller 12.

### Configuration of the Antenna Module 2

As shown in FIG. 1, the antenna module 2 includes an antenna side I/O terminal 201, an antenna 202, a control signal detector 203, a bidirectional amplifier 210, a temperature detector 220, an A-D converter 221, a feedback signal generator 222, and a signal superposer 223. Further, the bidirectional amplifier 210 is provided with a duplexer 211, the transmission amplifier 212, a reception amplifier 213, and a duplexer 214.

Each of electrical components constituting the antenna module 2 operates on an electric power supply supplied via the antenna cable 3. Further, the configuration of the antenna module 2 shown in FIG. 1 is housed in one casing which is not illustrated.

In the antenna module 2, both the duplexers 211, 214 of the bidirectional amplifier 210 are connected to the transmission amplifier 212 in the transmission mode. In such connection state, when the transmission signal has been transmitted via the antenna cable 3 from the communication radio 1, a radio wave of the transmission signal is emitted from the antenna 202 after transmission of the transmission signal through the antenna side I/O terminal 201, the duplexer 211, the transmission amplifier 212, the duplexer 214, and the antenna 202 in this order.

On the other hand, both of the duplexers 211 and 214 of the bidirectional amplifier 210 are connected to the reception amplifier 213 in the reception mode. In the reception mode, when the antenna 202 receives a radio wave, the reception signal is sent to the communication radio 1 after going through the antenna 202, the duplexer 214, the reception amplifier 213, the duplexer 211, the antenna side I/O terminal 201, and the signal line of the antenna cable 3 in this order.

In the present embodiment, as the transmission amplifier 212, a variable gain type power amplifier is used, and, the reception amplifier 213, a low noise amplifier is used. Further, an actual amplification rate of the transmission amplifier 212 may change according to temperature change, the gain of the transmission amplifier 212 is adjusted based on the temperature.

More practically, a gain adjustment is performed according to the control signal. The control signal is a signal generated by the control signal generator 13 of the communication radio 1, and such a control signal is superposed on the electric power voltage by the power superposer 17, which makes the superposed signal. The superposed signal is inputted to the antenna side I/O terminal 201 via the communication radio side I/O terminal 18 and the antenna cable 3.

The control signal detector 203 detects a control signal from the signal that is inputted to the antenna side I/O terminal 201 via the antenna cable 3.

A control signal is described here in detail. As an example is shown in FIG. 2, the control signal of the present embodiment is a digital signal, and consists of a start bit D0, a mode field D1, and a set value field D2. The start bit DO and the mode field D1 are respectively made up from one bit, and the set value field D2 is made up from two bits.

In FIG. 3, a part of a relation between a signal pattern of the control signal and an amplifier gain indicated by the signal pattern is illustrated. The example shown in FIG. 3 is an example of the signal pattern in the transmission mode. Therefore, the second bit in the signal pattern is always “1.”

Further, the set value field is either of “00”, “01”, “10”, or “11.” The set value is determined according to the temperature in the left column, and instructs to set a gain in the right column. Therefore, in the example of FIG. 3, the higher the temperature is, the higher the gain set value becomes (i.e., is instructed).

The control signal detector 203 also performs control of the duplexers 211 and 214, the transmission amplifier 212, and the reception amplifier 213 based on the detected control signal, in addition to detecting the control signal. More practically, when the mode field D1 of a control signal is “1”, the duplexers 211 and 214 are connected to the transmission amplifier 212, and, when the mode field D1 is “0”, the duplexers 211 and 214 are connected to the reception amplifier 213. Further, the gain of the transmission amplifier 212 is controlled based on the signal of the set value field D2. When the mode field D1 is “1”, the signal “1” of the mode field D1 is equivalent to “a transmission mode signal” in the claims.

The temperature detector 220 is a thermistor, for example, and detects the temperature of the antenna module 2, and inputs to the A-D converter 221 a temperature signal indicating the detected temperature. The A-D converter 221 converts the temperature signal into a digital signal, and inputs it to the feedback signal generator 222.

The feedback signal generator 222 generates, based on the inputted temperature signal, the feedback signal that includes the temperature information of the antenna module 2, and transmits the generated feedback signal to the signal superposer 223.

The signal superposer 223 superposes the feedback signal on a signal which flows through the signal line of the antenna cable 3 by inputting the feedback signal into the antenna side I/O terminal 201. Thereby, the feedback signal is detected by the temperature signal detector 19 after passing through the antenna cable 3, the power superposer 17 of the communication radio 1, and the receiver 16.

### Transmission Timing of the Control Signal and the Feedback Signal

FIG. 4 shows a time chart of voltage change in the antenna cable 3 in the present embodiment. In the example of FIG. 4, the control signal is superposed on the electric power voltage in a time period T0-T1. In the present embodiment, a time TO arrives at a lapse of both of (i) an IFS time, i.e., an Inter Frame Space time, and (ii) a back-off time which is subsequent to the IFS time after finding that, based on the carrier sensing, the communication channel is not used. Further, it is assumed that, at the time TO, a data to be transmitted is ready based on a transmission queue state.

In the example of FIG. 4, since the mode field D1 of the control signal is “1”, when the control signal detector 203 of the antenna module 2 detects the control signal, the antenna module 2 is switched to the transmission mode.

The transmission signal is transmitted from a time T1 that is immediately after transmitting the control signal. In other words, the control signal which includes the signal of switching to the transmission mode is transmitted to the antenna module 2 before the transmission of the transmission signal. Therefore, in comparison to the prior art in which the control signal itself controls the switching to the transmission mode, the switching scheme of the present disclosure enables an earlier switching to the transmission mode.

The communication radio 1 now transmits a 2-bit control signal which instructs to return to the reception mode to the antenna module 2, during a time period T2-T3 that is immediately after the transmission of the control signal. By receiving such a control signal, the antenna module 2 returns to the reception mode. Therefore, the radio communication system 100 is in the reception mode except for a transmission period of the transmission signal. Further, in the reception mode, carrier sensing is repeatedly performed at a preset timing. The end (i.e., a terminator) of the control signal that is transmitted to the antenna module 2 from the communication radio 1 during the T2-T3 time period may be predetermined, for example, as a 2-bit control signal when the communication radio 1 is in the transmission mode. Alternatively, it may be configured that, when the mode field D1 in the control signal is “0”, such a “0” field terminates the control signal. Further, by including the set value field in a control signal that instructs the switching to the reception mode and by setting the number of bits of the set value field to always have the same preset value, the end of the control signal is determined based on the same preset value of the number of bits.

After receiving such a control signal, the antenna module 2 in turn transmits the feedback signal to the communication radio 1. The feedback signal sent to the communication radio 1 is used for generation of the next control signal.

When the mode field D1 in the control signal is “0”, it is predictable that the transmission signal will not be transmitted after such “0” control signal, not to speak that a control signal will not be transmitted after transmission of a control signal. Thus, based on the reception of the control signal, a feedback signal is transmitted to the communication radio 1 from the antenna module 2. Thereby, a transmission timing of the feedback signal is prevented from overlapping with a transmission timing of transmitting a control signal or a transmission signal.

After the end of transmission of the transmission signal, the IFS time and the back-off time exit during which any device transmits a radio wave, and, after the lapse of the back-off time, the reception signal is received. In FIG. 4, for an illustration purpose, the transmission time of transmitting the control signal and the feedback signal is depicted as a period between (i) the end of transmission of the transmission signal and (ii) a start of reception of the reception signal. However, in an actual situation, the transmission time to transmit the transmission signal and/or the feedback signal is shorter than the IFS time.

Therefore, transmission of the feedback signal needs not be immediately after the control signal. That is, the feedback signal may be transmitted at a preset time within the IFS time.

### Effects of the Present Embodiment

As mentioned above, in the present embodiment, the communication radio 1 transmits the control signal for controlling (i) the gain of the transmission amplifier 212 of the antenna module 2 and (ii) the duplexers 211 and 214 to the antenna module 2 through the antenna cable 3, by superposing the control signal on the electric power voltage. Therefore, the antenna module 2 is controlled without affecting the transmission signal.

Further, in the present embodiment, the antenna module 2 is provided with the temperature detector 220, and the temperature of the antenna module 2 detected by the temperature detector 220 is transmitted to the communication radio 1 as the feedback signal. Further, in the control signal, a signal which instructs the gain of the transmission amplifier 212 which is determined based on the temperature of the antenna module 2 is included. Therefore, even when the antenna module 2 of the present embodiment is disposed in a harsh environment such as a vehicle roof, where the range of temperature change is very large, change/fluctuation of transmitted electric power due to the temperature change is prevented/mitigated.

Further, the present disclosure is not limited to each of the examples mentioned above, that is, various changes and modifications are included within the scope of the disclosure, as long as the example pertains to the core of the disclosure. Further, a combination of the different techniques that are described in respectively different embodiments/examples may also be possible.

### Modification 1

The above-mentioned embodiment exemplifies that the control signal is transmitted when it is determined that both of (i) the IFS time and (ii) the back-off time which is subsequent to the IFS time have lapsed after it is determined that the communication channel is not used based on the carrier sensing.

However, the control signal that does not include a signal of instructing the switching to the transmission mode may be transmitted in the following manner. That is, by performing the carrier sensing after shifting to an idle state from a busy condition and by determining that the communication channel is not used, a control signal may be transmitted somewhere during (i.e., in the middle of) the IFS time and the back-off time subsequent to it.

An example of the control signal that does not include a signal of instructing the switching to the transmission mode described above, a signal which consists of the start bit D0 and the set value field D2 in the above-mentioned embodiment may be considered, for example. In this case, a control signal instructing the switching to the transmission mode may be separately transmitted immediately before the transmission of the transmission signal.

### Modification 2

According to the above-mentioned embodiment, “a transmission start timing” in the claims is a timing immediately after the transmission of a control signal including the signal that instructs the switching to the transmission mode, transmission of the transmission signal is started immediately after the transmission of the control signal. However, such transmission scheme may be changed. That is, by taking into consideration a switch operation time of the antenna module 2 which is required for a switching operation of the antenna module 2 to the transmission mode, “the transmission start timing” may be set to a timing after a lapse of such a switch operation time from the transmission of the control signal.

### Modification 3

In the above-mentioned embodiment, it is described that the transmission of the transmission signal is performed after performing the carrier sensing according to a transmission standard of the vehicle-to-vehicle communication and the road-to-vehicle communication. However, the present disclosure may be applicable to a communication method that does not use the carrier sensing as a requirement.

When applying the present disclosure to the communication method which does not use the carrier sensing as a requirement, the communication radio 1 may transmit a control signal at an arbitrary time during which the transmission signal is not transmitted based on a self-determination whether the communication radio 1 itself is transmitting a transmission signal.

### Modification 4

According to the above-mentioned embodiment, the feedback signal is described as being transmitted during a period in which the transmission signal is not transmitted and the reception signal is not received. However, the feedback signal may be superposed on the reception signal for the transmission to the communication radio 1. The communication radio 1 is enabled to obtain a pulse-shape feedback signal by extracting a DC component out of the signal from the antenna module 2.

### Modification 5

According to the above-mentioned embodiment, the gain of the transmission amplifier 212 is adjusted by the control signal. However, alternatively to such gain control, or, in addition to such gain control, the gain of the reception amplifier 213 may also be adjusted by the control signal.

### Modification 6

In the above-mentioned embodiment, the transmission amplifier 212 and the reception amplifier 213 are provided for the antenna module 2 only. However, in addition to providing the transmission amplifier 212 and the reception amplifier 213 for the antenna module 2, the communication radio 1 may also have an amplifier.

### Modification 7

In the above-mentioned embodiment, the radio communication system 100 is installed in a vehicle. However, the radio communication system 100 may also be used in various apparatuses, such as a personal computer (PC), audio-visual (AV) equipment, and the like. When using the communication radio 1 in PC, AV equipment, etc., the communication radio 1 may be installed in PC, AF equipment etc., and the antenna module 2 may be disposed separately from the communication radio 1.

Although the present disclosure has been fully described in connection with preferred embodiment thereof with reference to the accompanying drawings, it is to be noted that various changes and modifications become apparent to those skilled in the art, and such changes, modifications, and summarized schemes are to be understood as being within the scope of the present disclosure as defined by appended claims.

What is claimed is:

1. A radio communication system comprising:
a radio;
an antenna side device positioned external to the radio; and
a transmission line connecting the radio to the antenna side device and supplying an electric power to the antenna side device, wherein
the radio outputs a transmission signal to the antenna side device through the transmission line by superposing the transmission signal on a power voltage,
the antenna side device outputs the transmission signal as a radio wave, and
the radio outputs a control signal to the antenna side device through the transmission line by superposing the control signal on the power voltage during a time when the radio does not output the transmission signal to the antenna side device.

2. The radio communication system of claim 1, wherein
the antenna side device outputs a reception signal to the radio through the transmission line that is indicative of a received radio wave,
during a time when the antenna side device does not receive the transmission signal or the control signal from the radio, the antenna side device outputs a feedback signal that notifies a state of the antenna side device to the radio through the transmission line, and
the control signal is determined based on the feedback signal.

3. The radio communication system of claim 2, wherein
the antenna side device includes a temperature detection circuit and a transmission amplifier with a variable gain,
the feedback signal indicates a detected temperature from the temperature detection circuit, and
the control signal includes a gain control signal that controls a gain of the transmission amplifier.

4. The radio communication system of claim 1, wherein
after outputting the control signal to the antenna side device, which includes a transmission mode signal for a switching of the antenna side device to a transmission mode, the radio outputs the transmission signal to the antenna side device at a transmission start timing that is determined based on a required switch time for the switching of the antenna side device to the transmission mode.

5. The radio communication system of claim 1, wherein
an Inter Frame Space (IFS) time is a time period after a busy-to-idle state transition of a communication channel,
a back-off time is a time period subsequent to the IFS time, and
based on carrier sensing of the communication channel, the radio outputs the control signal during the IFS time or the back-off time.

6. The radio communication system of claim 5, wherein
the carrier sensing of the communication channel is repeatedly performed at a preset timing.

7. A communication radio comprising:
a radio section;
an antenna side device positioned external to the radio section; and
a transmission line connecting the radio section to the antenna side device and supplying an electric power to the antenna side device, wherein
the radio section outputs a transmission signal to the antenna side device through the transmission line by superposing the transmission signal on a power voltage, and the antenna side device outputs the transmission signal as a radio wave, and
the radio section outputs a control signal to the antenna side device through the transmission line by superposing the control signal on the power voltage during a time when the radio section does not output the transmission signal to the antenna side device.

8. A communication antenna comprising:
a radio section;
an antenna section positioned external to the radio section; and
a transmission line connecting the radio section to the antenna section and supplying an electric power to the antenna section, wherein
the radio section outputs a transmission signal to the antenna section through the transmission line by superposing the transmission signal on a power voltage, and the antenna section outputs the transmission signal as a radio wave, and
the radio section outputs a control signal to the antenna section through the transmission line by superposing the control signal on the power voltage during a time when the radio section does not output the transmission signal to the antenna section.

9. A method for communicating using a radio communication system, the radio communication system includes a radio, an antenna side device that is positioned external to the radio, and a transmission line that connects the radio to the antenna side device and supplies an electric power to the antenna side device, the method comprising:
superposing a transmission signal on a power voltage;
outputting the transmission signal from the radio to the antenna side device through the transmission line as a radio wave;
superposing a control signal on the power voltage; and
outputting the control signal from the radio to the antenna side device through the transmission line when the radio does not output the transmission signal to the antenna side device.

10. The method for communicating using a radio communication system of claim 9, further comprising:
outputting a reception signal, which is indicative of a received radio wave from the antenna side device, to the radio through the transmission line; and
outputting a feedback signal that notifies a state of the antenna side device from the antenna side device to the radio through the transmission line during a time when the antenna side device does not receive the transmission signal or the control signal from the radio.

11. The method for communicating using a radio communication system of claim 9, wherein
outputting the transmission signal from the radio to the antenna side device is started at a transmission start timing that is determined based on a required switch time for switching of the antenna side device to the transmission mode after outputting the control signal from the radio to the antenna side device, which includes a transmission mode signal for the switching of the antenna side device to the transmission mode.
